(19) United States
(12) Patent Application Publication
(10) Pub. No.: US 2026/0172613 A1
(43) Pub. Date: Jun. 18, 2026

(54) SYSTEM AND METHOD OF GENERATING DIGITAL ITEM RECOMMENDATIONS

(71) Applicant: Y.E. Hub Armenia LLC, Yerevan (AM)

(72) Inventors: Daniil BURLAKOV, Moscow (RU); Mikhail DEKTIAREV, Moscow (RU); Aleksandr SAFRONOV, Moscow (RU)

(21) Appl. No.: 19/419,737

(22) Filed: Dec. 15, 2025

(30) Foreign Application Priority Data
Dec. 18, 2024 (RU) 2024138329

(51) Int. Cl. H04N 21/25; G06N 20/00

(52) U.S. Cl. CPC H04N 21/251; G06N 20/00

(57) ABSTRACT

A method and a server for generating item recommendations for users of a digital recommendation platform are provided. The method includes training a machine-learning algorithm (MLA) to identify a next digital item from to be provided to a given user. The training includes: identifying a set of least interacted digital items; determining, for a given least interacted digital item, at least one prior user having interacted therewith; generating, based on respective pluralities of user features of the at least one prior user, a respective auxiliary plurality of item features; augmenting the respective plurality of item features of the given least interacted item with the respective auxiliary plurality of item features, thereby generating a respective augmented plurality of item features for the given least interacted digital item; and training the MLA based on the respective augmented pluralities of item features of the set of least interacted digital items.

### CROSS-REFERENCE

The present application claims priority to Russian Patent Application No. 2024138329, entitled “System and Method of Generating Digital Item Recommendations”, filed Dec. 18, 2024, the entirety of which is incorporated herein by reference.

### FIELD

The present technology relates generally to recommendations systems; and in particular, to a method of generating digital item recommendations for users of digital recommendation platforms.

### BACKGROUND

Digital recommendation platforms host various digital items to be provided to the users thereof. Some of the digital recommendation platforms comprise streaming platforms, for example, audio or video streaming platforms as a Sportify™ audio streaming platform, a Yandex.Music™ audio streaming platform, a Netflix™ video streaming platform, an Amazon™ Prime Video streaming platform, and the like, hosting various audio tracks and video clips. Other digital recommendation platforms can be implemented as online listing platforms, such as a Yandex™ Market online listing platform, an Amazon™ online listing platform, an Ozon.ru™ online listing platform, and others. These platforms allow the users to purchase various goods and services online. The given digital recommendation platform can be configured to host millions or even tens or hundreds of millions of digital items for presentation to the users.

To assist the user in navigating through such a number of digital items hosted by the given digital recommendation platform and increase their user satisfaction from interacting therewith, the given digital recommendation platform can be configured to provide the user with user recommendations. For example, a request for the user recommendations can be triggered by the user appreciating a given digital item on the given digital recommendation platform, such as an audio track on an audio streaming platform. In response, the given digital recommendation platform can be configured to provide a list of recommended digital item to be presented to the user after the given digital item. In another example, the given digital recommendation platform can be configured to determine and further provide the list of recommended digital items to the user in response to the user starting up the given digital recommendation platform on her/his electronic device or the request for recommendations expressly. The recommended digital items can be, for example, of a similar category or provided by a same item source, such as a singer.

The given digital recommendation platform is typically configured to determine the list recommended digital items based on past user interactions of users of the digital recommendation platform with the plurality of digital items thereof. Such a list can include, for example, tens, hundreds, or thousands recommended digital items.

One of the technical problems associated with providing digital item recommendation to the users is that typically, digital recommendation platforms tend to provide the users with digital items that are among currently most popular digital items on a given digital recommendation platform. In an example where the given digital recommendation platform is the audio streaming platform, the audio streaming platform can be configured to provide the given user with recommended digital items including audio tracks that are similar to the audio tracks with which the given user has positively engaged (such as by providing a LIKE thereto) but are from most popular audio tracks of the audio streaming platform, that is, those with which a majority of the users thereof have positively engaged. In other words, the digital recommendations provided by conventional digital recommendation platforms may suffer from popularity bias. In other words, the given user may be restricted only to currently popular digital items on the digital recommendation platform, without being introduced to rarer interacted digital items that could also be of interest to her or him. This may affect the overall experience and further interest of the given user in interacting with the given digital recommendation platform.

Certain prior art approaches have been proposed to tackle the above-identified technical problem.

Chinese Patent Application Publication No.: 116,304,288-A, published on Jun. 23, 2023, assigned to Institute of Information Engineering of CAS, and entitled “INTELLIGENT RECOMMENDATION METHOD FOR FORWARD-FLOW BIAS BASED ON NEURAL NETWORK OF DOUBLE-BRANCH GRAPH,” discloses an intelligent recommendation method for removing popularity bias based on a double-branch graph neural network. The method comprises: acquiring an original data set; deleting user article exchange records of hot articles in the original data set to obtain a long-tail data set; based on the original data set and the long-tail data set, respectively constructing an original sub-graph and a long-tail sub-graph; and for the original sub-graph and the long-tail sub-graph, information propagation is carried out through a graph neural network, and in the training process, the weight of the graph neural network corresponding to the long-tail sub-graph is gradually increased based on a dynamically adjusted parameter, so that an article recommendation result of the user is obtained based on the graph neural network corresponding to the trained long-tail sub-graph. The problem of popularity offset caused by the fact that data obeys long-tail distribution in a traditional recommendation scene is solved.

### SUMMARY

Therefore, there is a need for systems and methods which avoid, reduce, or overcome the limitations of the prior art.

Developers of the present technology have appreciated that the popularity bias in the provided digital recommendations can be decreased hence diversifying the digital recommendations for the given user by using a specifically trained machine-learning algorithm (MLA) that can be executed by the given digital recommendation platform.

More specifically, the developers have devised methods and systems for training the MLA to identify, from a plurality of digital items stored by the given digital recommendation platform, digital items that would be among least popular digital items of the given digital recommendation platform but might be of interest to the given user. To do so, according to at least some non-limiting embodiments of the present technology, the MLA can be trained to identify, for the given user, the recommendable digital items that include digital items that have been least interacted with, but by the users of the given digital recommendation platform that are similar to the given user.

By doing so, the present methods and systems may allow diversifying the digital recommendations to be provided to the given user with least interacted digital items, introducing the given user to new content that may interest them, which may enhance user experience of the given user with the given digital recommendation platform.

More specifically, in accordance with a first broad aspect of the present technology, there is provided a computer-implemented method for generating item recommendations for users of a digital recommendation platform. The digital recommendation platform stores a plurality of digital items. The method comprises training a machine-learning algorithm (MLA) to identify a next digital item from the plurality of digital items to be provided to a given user. The training includes: acquiring, for the given digital item of the plurality of digital items of the digital recommendation platform, a respective plurality of item features of the given digital item; acquiring, for a given user of the digital recommendation platform, a respective plurality of user features of the given user; identifying, from the plurality of digital items, a set of least interacted digital items; determining, for a given least interacted digital item of the set of least interacted digital items, at least one prior user having interacted therewith; generating, for the given least interacted digital item, based on respective pluralities of user features of the at least one prior user, a respective auxiliary plurality of item features; augmenting the respective plurality of item features of the given least interacted item with the respective auxiliary plurality of item features, thereby generating a respective augmented plurality of item features for the given least interacted digital item; generating a training set of data comprising a plurality of training digital objects, a given training digital object of which comprises: (i) the respective plurality of user features of a given prior user of the at least one prior user associated with the given least interacted digital item; and (ii) a respective label including the respective augmented plurality of item features of the given least interacted digital item of the set of least interacted digital items, with which the given prior user has interacted; feeding, to the MLA, each one of the plurality of training digital objects, thereby causing the MLA to generate a respective prediction including the respective plurality of item features of a respective intermediate next digital item for the given user; and training the MLA to identify, based on the user features of the given user, a respective least interacted digital item from the set of least interacted digital items as being the next digital item to be provided to the given user so that: the more similar are user features of prior users associated with the respective least interacted digital item to the user features of the given user, the more likely the MLA is to identify the respective least interacted digital item as being the next digital item to be provided to the given user.

In some implementations of the method, the given training digital object further comprises a combination of respective pluralities of item features of other digital items with which the given prior user has interacted.

In some implementations of the method, identifying the given least interacted digital item of the set of least interacted digital items comprises identifying a digital item with which no more than a predetermined proportion of the users of the digital recommendation platform has interacted.

In some implementations of the method, identifying the given least interacted digital item of the set of least interacted digital items comprises identifying a digital item having no more than a predetermined number of indications of user interactions.

In some implementations of the method, the identifying the set of least interacted digital items comprises: ranking the plurality of digital items of the digital recommendation platform in accordance with indications of user interactions therewith, thereby generating a ranked list of digital items; and selecting bottom N digital items from the ranked list of digital items.

In some implementations of the method, the generating the respective auxiliary plurality of item features comprises determining a combination of the respective pluralities of user features of the at least one prior user having interacted with the given least interacted digital items.

In some implementations of the method, the augmenting the respective plurality of item features of the given least interacted item with the respective auxiliary plurality of item features comprises determining a combination of the respective plurality of item features and the respective auxiliary plurality of item features.

In some implementations of the method, the training comprises using a cosine similarity loss function.

In some implementations of the method, the method further comprises using the MLA for generating the item recommendations for the given user, by: generating an in-use digital object that includes: (i) the respective plurality of user features of the given user; and (ii) a combination of respective pluralities of item features of past digital items with which the given user has interacted; feeding the in-use digital object to the MLA, thereby causing the MLA to identify, in the plurality of digital items, a given in-use digital item; and causing presentation of the given in-use digital item as being the next digital item for the given user.

In some implementations of the method, prior to the causing, the method further comprises: generating a respective item feature vector representative of the given digital item; feeding the respective plurality of item features of the given digital item as an input feature to a second MLA, thereby causing the second MLA to identify, in the plurality of digital items, a given other in-use digital item; the second MLA having been trained to generate the item recommendation based on outputs of the MLA; and causing presentation of the given other in-use digital item as being the next digital item for the given user.

In some implementations of the method, the second MLA comprises a Gradient Boosting Decision Tree-based MLA.

In some implementations of the method, the MLA comprises a Deep Semantic Similarity Model (DSSM).

Further, in accordance with a second broad aspect of the present technology, there is provided a server for generating item recommendations for users of a digital recommendation platform. The digital recommendation platform stores a plurality of digital items. The server comprises at least one processor and at least one non-transitory computer-readable medium storing executable instructions, which, when executed by the at least one processor, cause the server to: train a machine-learning algorithm (MLA) to identify a next digital item from the plurality of digital items to be provided to a given user, by: acquiring, for the given digital item of the plurality of digital items of the digital recommendation platform, a respective plurality of item features of the given digital item; acquiring, for a given user of the digital recommendation platform, a respective plurality of user features of the given user; identifying, from the plurality of digital items, a set of least interacted digital items; determining, for a given least interacted digital item of the set of least interacted digital items, at least one prior user having interacted therewith; generating, for the given least interacted digital item, based on respective pluralities of user features of the at least one prior user, a respective auxiliary plurality of item features; augmenting the respective plurality of item features of the given least interacted item with the respective auxiliary plurality of item features, thereby generating a respective augmented plurality of item features for the given least interacted digital item; generating a training set of data comprising a plurality of training digital objects, a given training digital object of which comprises: (i) the respective plurality of user features of a given prior user of the at least one prior user associated with the given least interacted digital item; and (ii) a respective label including the respective augmented plurality of item features of the given least interacted digital item of the set of least interacted digital items, with which the given prior user has interacted; feeding, to the MLA, each one of the plurality of training digital objects, thereby causing the MLA to generate a respective prediction including the respective plurality of item features of a respective intermediate next digital item for the given user; and training the MLA to identify, based on the user features of the given user, a respective least interacted digital item from the set of least interacted digital items as being the next digital item to be provided to the given user so that: the more similar are user features of prior users associated with the respective least interacted digital item to the user features of the given user, the more likely the MLA is to identify the respective least interacted digital item as being the next digital item to be provided to the given user.

In some implementations of the server, the given training digital object further comprises a combination of respective pluralities of item features of other digital items with which the given prior user has interacted.

In some implementations of the server, to identify the given least interacted digital item of the set of least interacted digital items, the executable instructions further cause the server to identify a digital item with which no more than a predetermined proportion of the users of the digital recommendation platform has interacted.

In some implementations of the server, to identify the given least interacted digital item of the set of least interacted digital items, the executable instructions further cause the server to identify a digital item having no more than a predetermined number of indications of user interactions.

In some implementations of the server, to identify the set of least interacted digital items, the executable instructions cause the server to: rank the plurality of digital items of the digital recommendation platform in accordance with indications of user interactions therewith, thereby generating a ranked list of digital items; and select bottom N digital items from the ranked list of digital items.

In some implementations of the server, to generate the respective auxiliary plurality of item features, the executable instructions cause the server to determine a combination of the respective pluralities of user features of the at least one prior user having interacted with the given least interacted digital items.

In some implementations of the server, to augment the respective plurality of item features of the given least interacted item with the respective auxiliary plurality of item features, the executable instructions cause the server to determine a combination of the respective plurality of item features and the respective auxiliary plurality of item features.

In some implementations of the server, the executable instructions further cause the server to use the MLA for generating the item recommendations for the given user, by: generating an in-use digital object that includes: (i) the respective plurality of user features of the given user; and (ii) a combination of respective pluralities of item features of past digital items with which the given user has interacted; feeding the in-use digital object to the MLA, thereby causing the MLA to identify, in the plurality of digital items, a given in-use digital item; and causing presentation of the given in-use digital item as being the next digital item for the given user.

In the context of the present specification, a “server” is a computer program that is running on appropriate hardware and is capable of receiving requests (e.g. from electronic devices) over a network, and carrying out those requests, or causing those requests to be carried out. The hardware may be implemented as one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. In the context of the present specification, the term “electronic device” implies that a device can function as a server for other electronic devices, however it is not required to be the case with respect to the present technology. Thus, some (non-limiting) examples of electronic devices include self-driving unit, personal computers (desktops, laptops, netbooks, etc.), smartphones, and tablets, as well as network equipment such as routers, switches, and gateways. It should be understood that in the present context the fact that the device functions as an electronic device does not mean that it cannot function as a server for other electronic devices.

In the context of the present specification, the expression “information” includes information of any nature or kind whatsoever capable of being stored in a database. Thus, information includes, but is not limited to visual works (e.g. maps), audiovisual works (e.g. images, movies, sound records, presentations etc.), data (e.g. location data, weather data, traffic data, numerical data, etc.), text (e.g. opinions, comments, questions, messages, etc.), documents, spreadsheets, etc.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the words “first”, “second”, “third”, etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims, and accompanying drawings where:

FIG. 1 depicts a schematic diagram of an example computer system configurable for implementing certain non-limiting embodiments of the present technology;

FIG. 2 depicts a schematic diagram of a networked computing environment including the computer system of FIG. 1 and being suitable for use with certain non-limiting embodiments of the present technology;

FIG. 3 depicts a schematic diagram of a Graphical User Interface of a digital recommendation platform executed by a server present in the networked computing environment of FIG. 2, in accordance with certain non-limiting embodiments of the present technology;

FIG. 4 depicts a schematic diagram of a machine-learning model architecture used for implementation at least some non-limiting embodiments of the present technology;

FIG. 5 depicts a schematic diagram of a step for generating, by the server present in the networked computing environment of FIG. 2, a given training digital object for training a machine-learning algorithm (MLA) based on the machine-learning model architecture of FIG. 4, to identify recommended digital items, in accordance with certain non-limiting embodiments of the present technology;

FIG. 6 depicts a schematic diagram of a step for generating, by the server present in the networked computing environment of FIG. 2, a given in-use digital object for using the MLA to identify the recommended digital items, in accordance with certain non-limiting embodiments of the present technology; and

FIG. 7 depicts a flowchart diagram of a method of identifying, by the server present in the networked computing environment in FIG. 2, the recommended digital items, item recommendations, in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random-access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

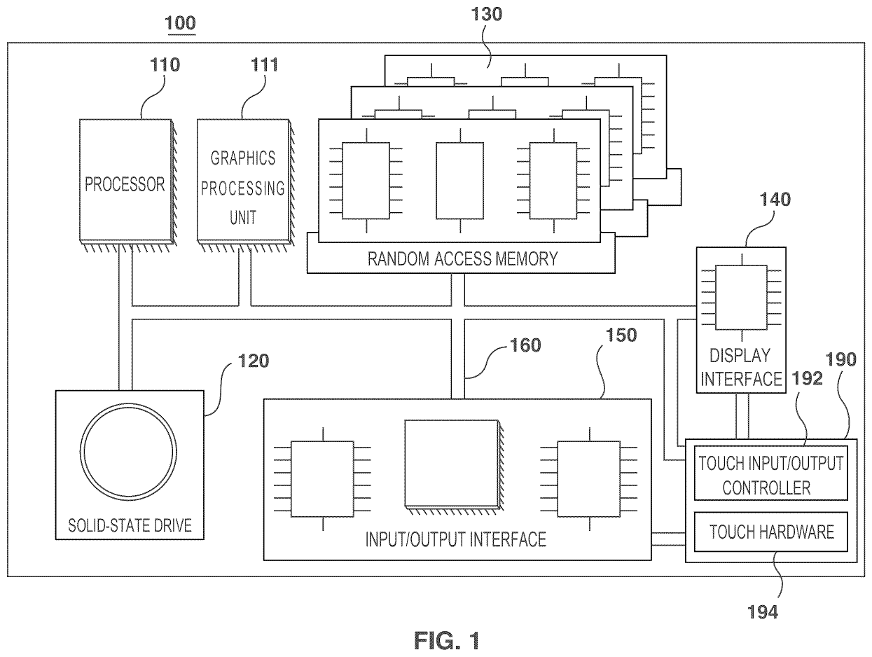

With reference to FIG. 1, there is depicted a computer system 100 suitable for use with some implementations of the present technology. The computer system 100 comprises various hardware components including one or more single-or multi-core processors collectively represented by a processor 110, a graphics processing unit (GPU) 111, a solid-state drive 120, a random-access memory 130, a display interface 140, and an input/output interface 150.

Communication between the various components of the computer system 100 may be enabled by one or more internal and/or external buses 160 (e.g., a PCI bus, universal serial bus, IEEE 1394 “Firewire” bus, SCSI bus, Serial-ATA bus, etc.), to which the various hardware components are electronically coupled.

The input/output interface 150 may be coupled to a screen 190 and/or to the one or more internal and/or external buses 160. In some non-limiting embodiments of the present technology, the screen 190 can be implemented as a touch screen and hence comprise touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some non-limiting embodiments of the present technology, the input/output interface 150 may be connected to a keyboard (not separately depicted), a mouse (not separately depicted) or a trackpad (not separately depicted) allowing the user to interact with the computer system 100 in addition to or instead of the screen 190.

It is noted some components of the computer system 100 can be omitted in some non-limiting embodiments of the present technology. For example, the keyboard and the mouse (both not separately depicted) can be omitted, especially (but not limited to) where the computer system 100 is implemented as a compact electronic device, such as a smartphone.

According to implementations of the present technology, the solid-state drive 120 stores program instructions suitable for being loaded into the random-access memory 130 and executed by the processor 110 and/or the GPU 111. For example, the program instructions may be part of a library or an application.

### Networked Computing Environment

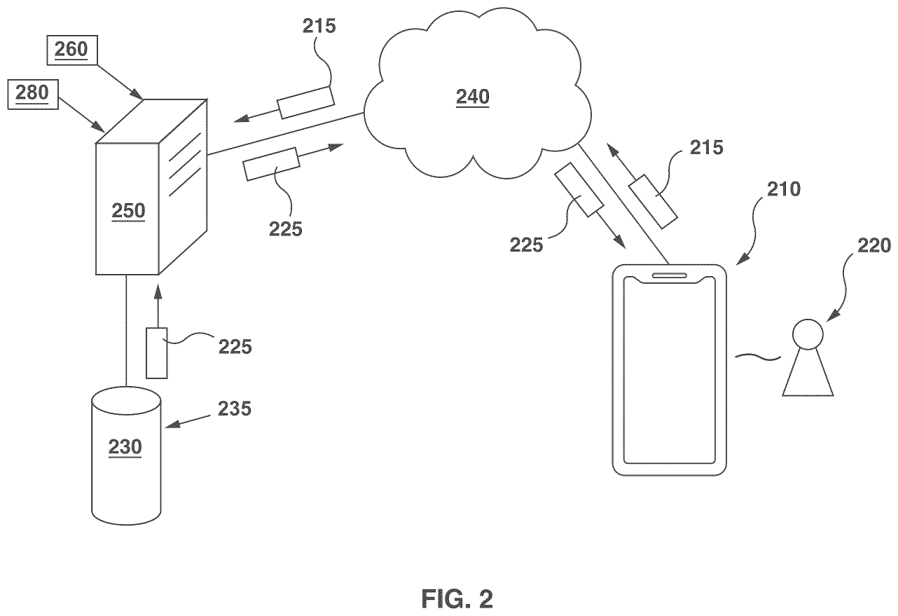

With reference to FIG. 2, there is depicted a schematic diagram of a networked computing environment 200 suitable for use with some non-limiting embodiments of the present technology. The networked computing environment 200 includes an electronic device 210 communicatively coupled, via a communication network 240, with a server 250. In the non-limiting embodiments of the present technology, the electronic device 210 may be associated with a user 220.

In the non-limiting embodiments of the present technology, the electronic device 210 may be any computer hardware that is capable of running a software appropriate to the relevant task at hand. Thus, some non-limiting examples of the electronic device 210 may include personal computers (desktops, laptops, netbooks, etc.), smartphones, and tablets. Thus, the electronic device 210 may comprise some or all components of the computer system 100 depicted in FIG. 1.

According to certain non-limiting embodiments of the present technology, the server 250 can be configured to host a digital recommendation platform 260; and the processor 110 of the electronic device 210 can be configured to access the digital recommendation platform 260 via the communication network 240. Broadly speaking, the digital recommendation platform 260 is a web resource providing the user 220 with access to a plurality of digital items 235 stored in a database 230 communicatively coupled to the server 250 via a respective communication link. More specifically, the digital recommendation platform 260 can be configured to identify digital items that may interest the user 220 and further transmit the indications of such digital items to the electronic device 210 for user's appreciation.

It is not limited how the digital recommendation platform 260 can be implemented. In some non-limiting embodiments of the present technology, the digital recommendation platform 260 can be implemented as an audio streaming platform, such as a Sportify™ audio streaming platform, a Yandex.Music™ audio streaming platform, a YouTube.Music™ audio streaming platform, and others; and the plurality of digital items 235 stored in the database 230 can comprise various audio tracks, such as songs, podcasts, audio books, and the like. In other non-limiting embodiments of the present technology, the digital recommendation platform can be implemented as video streaming platform, such as a Netflix™ video streaming platform, an Amazon™ Prime Video streaming platform, and others; and the plurality of digital items 235 can comprise video clips, films, and TV programs, as an example. In yet other non-limiting embodiments of the present technology, the digital recommendation platform 260 can be implemented as an online listing platform, such as a Yandex.Market™ online listing platform, and Amazon™ online listing platform; and the plurality of digital items 235 can comprise classified listings of various goods and services available for online purchasing. Other implementations of the digital recommendation platform 260 are also envisioned without departing from the scope of the present technology.

In some non-limiting embodiments of the present technology, the server 250 can be implemented as a conventional computer server and may comprise some or all of the components of the computer system 100 of FIG. 1. In one non-limiting example, the server 250 is implemented as a Dell™ PowerEdge™ Server running the Microsoft™ Windows Server™ operating system but can also be implemented in any other suitable hardware, software, and/or firmware, or a combination thereof. In the depicted non-limiting embodiments of the present technology, the server 250 is a single server. In alternative non-limiting embodiments of the present technology (not depicted), the functionality of the server 250 may be distributed and may be implemented via multiple servers.

In some non-limiting embodiments of the present technology, the server 250 can be operated by the same entity that has provided the digital recommendation platform 260. For example, if the digital recommendation platform 260 is the Yandex.Music™ audio streaming platform, the server 250 can also be operated by Yandex LLC of 16 Lev Tolstoy Street, Moscow, 119021, Russia. In alternative non-limiting embodiments of the present technology, the server 250 can be operated by an entity different from the one that has provided the digital recommendation platform 260.

For example, using the electronic device 210, the user 220 can be enabled to access the digital recommendation platform 260 from the electronic device 210. Further, the user 220 can be enabled to submit a recommendation request 215 to server 250. In response, the server 250 can be configured to (i) identify a set of recommended digital items 225 and (ii) transmit indications of the set of recommended digital items 225 to the electronic device for presentation to the user 220. It is not limited how the recommendation request 215 can be submitted by the user 220.

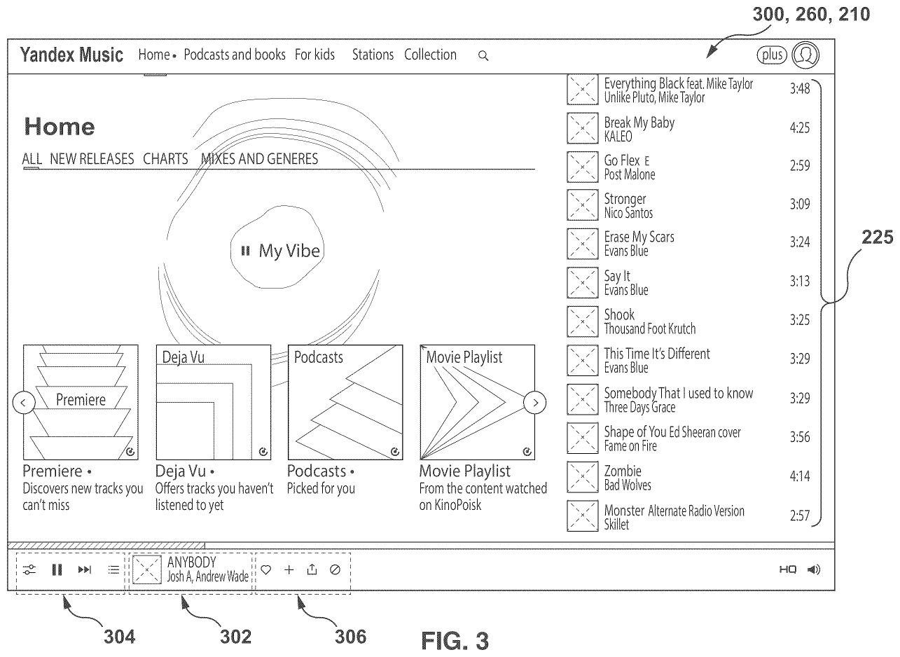

How the recommendation request 215 can be submitted to the server 250; and how, in response, the server 250 can further be configured to determine the set of recommended digital items 225, in accordance with certain non-limiting embodiments of the present technology, will be described below withe reference to FIGS. 3 to 5.

### Communication Network

In some non-limiting embodiments of the present technology, the communication network 240 is the Internet. In alternative non-limiting embodiments of the present technology, the communication network 240 can be implemented as any suitable local area network (LAN), wide area network (WAN), a private communication network or the like. It should be expressly understood that implementations for the communication network are for illustration purposes only. How a respective communication link (not separately numbered) between each one of the electronic device 210, the server 250, and the communication network 240 is implemented will depend, inter alia, on how each one of the electronic device 210 and the server 250 is implemented. Merely as an example and not as a limitation, in those embodiments of the present technology where the electronic device 210 is implemented as a wireless communication device such as the smartphone, the communication link can be implemented as a wireless communication link. Examples of wireless communication links include, but are not limited to, a 3G communication network link, a 4G communication network link, and the like. The communication network 240 may also use a wireless connection with the server 250.

### Recommendation Platform

With reference to FIG. 3, there is depicted a graphical user interface (GUI) 300 of the digital recommendation platform 260 rendered on the screen 190 of the electronic device 210 associated with the user 220, in accordance with certain non-limiting embodiments of the present technology.

According to certain non-limiting embodiments of the present technology, the server 250 can be configured to cause the electronic device 210 to render the GUI 300 in response to the user 220 submitting a request for accessing the digital recommendation platform 260, such as by submitting a Universal Resource Locator (URL) of the server 250 to a browser application (not separately depicted) of the electronic device 210 or launching thereon a native application (not separately numbered in FIG. 3) associated with the digital recommendation platform 260.

As it can be appreciated, in some non-limiting embodiments of the present technology, the GUI 300 can include at least: (i) respective indications of at least a portion of the set of recommended digital items 225, defined by dimensions of a screen of the electronic device 210; (ii) an indication of a currently appreciated digital item 302; control actuators 304 enabling the user 220 to control the presentation of a given recommended digital item; and (iii) feedback actuators 306 enabling the user 220 to leave their feedback on the given recommended digital item of the set of recommended digital items 225, such as the currently appreciated digital item 302.

Although in the embodiments depicted in FIG. 3, the GUI 300 is representative of the digital recommendation platform 260 implemented as an audio streaming platform, it should be expressly understood that, in other non-limiting embodiments of the present technology, similar GUIs can be rendered for other types of the digital recommendation platform 260, non-exhaustively listed above.

Further, it is not limited how the recommendation request 215 for the set of recommended digital items 225 can be submitted from electronic device 210. In some non-limiting embodiments of the present technology, the user 220 can be enabled, such as via a dedicated actuator (such as “Play Radio”, in the example where the digital recommendation platform 260 is an audio streaming platform, not depicted in FIG. 3) of the GUI 300, to expressly submit the recommendation request 215 to the server 250. In other non-limiting embodiments of the present technology, the recommendation request 215 can be triggered by the user 220 accessing the digital recommendation platform 260 from the electronic device 210, launching the GUI 300. In yet other non-limiting embodiments of the present technology, the user 220 can implicitly submit the recommendation request 215 to the digital recommendation platform 260 by selecting the given digital item of the plurality of digital items 235 for appreciation.

In some non-limiting embodiments of the present technology, the server 250 can be configured to generate the set of recommended digital items 225 for the user 220 based on past user interactions of users of the digital recommendation platform 260 with the plurality of digital items 235. According to certain non-limiting embodiments of the present technology, such user interactions of the users of the digital recommendation platform 260, such as those of the user 220, may be indicative of one of a positive user engagement or a negative user engagement with the given digital item of the plurality of digital items 235. Broadly speaking, the positive user engagement of the user 220 with the given digital item is indicative of that the user 220 has found the given digital item of interest, or in other words, has been satisfied with the given digital item presented thereto. Thus, by way of example, and not as a limitation, the user interactions of the user 220 indicative of the positive user engagement with the given digital item can include: (i) selecting the given digital item for appreciation; (ii) searching for the given digital item on the digital recommendation platform 260; (iii) sharing the given digital item via accounts of the user 220 on social networks; (iv) putting presentation of the given digital item on repeat; (v) adding the given digital item to a list of favorite digital items of the user 220; and (vi) providing positive user feedback under the given digital item.

By contrast, the negative user engagement of the user 220 with the given digital item can denote that the user 220 has found the given digital item dissatisfying. Thus, the user interactions of the user 220 indicative of the negative user engagement with the given digital item of the plurality of digital items can include, for example, without limitation: (i) skipping forward the given digital item; (ii) skipping the given digital item in its entirety to a sequentially following digital item; (iii) aborting the presentation of the given digital item followed by searching for an other digital item for appreciation; (iv) providing negative user feedback to the given digital item; and the like. Other user interactions of the user 220, indicative of both the positive and negative user engagement with the given digital item, are also envisioned without departing from the scope of the present technology.

Further, it is not limited how the digital recommendation platform 260 can be configured to enable the user feedback for each one of the plurality of digital items 235. In some non-limiting embodiments of the present technology, as mentioned above, the GUI 300 can include the feedback actuators 306 enabling the user feedback to be indicated by a binary value, such as “LIKE” or “DISLIKE”, respectively indicative of the positive or negative user engagement of the user 220 with the given digital item. In other non-limiting embodiments of the present technology, the feedback actuators 306 can include a different configuration (such as star indicators, emotion indicators, and the like, not depicted) enabling indication of the user feedback by one of values of a predetermined value range, such as from “1” to “5” or from “1” to “10”, for example, where “1” is indicative of the negative user engagement of the user 220 with the given digital item, and “5” or “10”, respectively, are indicative the positive user engagement of the user 220 with the given digital item.

In alternative non-limiting embodiments of the present technology, the GUI 300 of the digital recommendation platform 260 can include additional interface elements enabling the user 220 to indicate the user feedback in a form of a user comment and/or review on the given digital item. Further, in these embodiments, the server 250 can be configured to determine whether the user comments and/or reviews are indicative of the positive or negative user engagement of the user 220 with the given digital item. To that end, for example, the server 250 can be configured to execute a Natural Language Processing (NLP) model configured to process and understand natural human language. It is not limited how the NLP model can be implemented, and in various non-limiting embodiments of the present technology, the NLP model can be implemented based on artificial neural networks (NN), such as a Transformed-based NN, a Long Short-Term Memory NN, a Recurrent NN, and the like. In these embodiments, the NLP model is preliminarily trained based on large corpora of texts including natural human language. In specific non-limiting embodiments, the NLP model can be implemented and trained as described in a co-owned Russian Patent Application No.: 2021138538, filed with the Russian Federal Institute of Industrial Property on Dec. 23, 2021, and entitled “METHOD AND SYSTEM FOR RECOGNIZING A USER UTTERANCE”, the content of which is incorporated herein by reference in its entirety.

In some non-limiting embodiments of the present technology, the server 250 can be configured to identify recommended digital items for the set of recommended digital items 225 that have similar item features with those digital items, with which the user 220 has had most positive user engagement, as mentioned above. In another example, the server 250 can be configured to identify the recommended digital items for inclusion thereof in the set of recommended digital items 225 among those having received positive user engagements of other users of the digital recommendation platform 260 that have similar user features with the user 220.

According to certain non-limiting embodiments of the present technology, the item features associated with the given digital item may be indicative of inherent parameters thereof; and, as it can be appreciated, can depend on a nature of the given current digital item. For example, in those embodiments where the digital recommendation platform 260 is an online streaming platform, and the given digital item is a respective audio track, the item features can include, without limitation, (i) a genre of the respective audio track; (ii) a predetermined mood to be induced by the respective audio track; (iii) a period of popularity associated with the respective audio track, such as the sixties, the seventies, the nineties, and the like; (iv) a respective item source of the respective audio track; (v) a duration of the respective audio track; (vi) a release date of the respective audio track; (vii) a rhythm of the respective audio track; (viii) an album of the respective audio track; (ix) an item ID number in the database 230; and the like. According to certain non-limiting embodiments of the present technology, the respective item source can include at least one of: an artist associated with the given digital item, a producer or a production studio associated with the given digital item, and an entity having copyright on the given digital item.

Further, the user features of a given user of the digital recommendation platform 260, such as the user 220, can include, without limitation: (i) sociodemographic characteristics of the user 220, which may further include, without limitation, an age of the user 220, a gender of the user 220, an employment status of the user 220, an average income of the user 220, and the like; (ii) data indicative of a search history of the user 220; (iii) data indicative of a web browsing history of the user 220; and the like.

Further, in some non-limiting embodiments of the present technology, the server 250 can be configured to identify the set of recommended digital items 225 such that a likelihood value of the positive user engagement of the user 220 with each digital item of the set of recommended digital items 225 is maximized. In other non-limiting embodiments of the present technology, the server 250 can be configured to identify the set of recommended digital items 225 such that a likelihood value of the negative user engagement of the user 220 with each one of the set of recommended digital items 225 is minimized.

However, certain conventional approaches to identifying the set of recommended digital items 225 based on similarity to previously appreciated digital items to maximize the likelihood value of the positive user engagement may have certain disadvantages. One of such disadvantages is in that the server 250, using one of these conventional approaches, can be configured to identify the set of recommended digital items 225 that would suffer from a lack of diversity. More specifically, these conventional approaches, in order to maximize the likelihood of the positive user engagement of the user 220 with the set of recommended digital items 225, can include identifying digital items that would be among the most currently popular digital items of the digital recommendation platform 260. In other words, the server 250 could be configured to include, in the set of recommended digital items 225 for the user 220, those digital items that are similar to those with which the user 220 has interacted, but from those digital items with which the majority of users of the digital recommendation platform 260 have interacted.

Such an approach to generating the set of recommended digital items 225 may restrict the user 220 only to the most currently popular digital items of the digital recommendation platform 260 without introducing more rare content thereof that might also interest the user 220. Overall, this may result in the user 220 losing their interest in the provided content, affecting the user experience of the user 220 with the digital recommendation platform 260 and associated services.

To address this technical problem, the developers of the present technology have devised the methods and system described herein that are directed to identifying those digital items for including in the set of recommended digital item 225 that would meet both of the following conditions: (1) recommendable digital items to be included in the set of recommended digital items 225 for the user 220 would be among the least popular, that is, the least interacted digital items of the digital recommendation platform 260; however (2) these recommendable digital items have been interacted with by those users of the digital recommendation platform 260 that are similar to, that is, have at least some common users features as listed above with the user 220.

To do so, the present methods include training a specific machine-learning algorithm (MLA), such as an MLA 280, that the server 250 can be configured to execute to identify the set of recommended digital items 225, in accordance with certain non-limiting embodiments of the present technology.

In the non-limiting embodiments of the present technology, the MLA 280 may be based on neural networks (NN), convolutional neural networks (CNN), decision tree models, gradient boosted decision tree-based MLA, association rule learning based MLA, Deep Learning based MLA, inductive logic programming based MLA, support vector machines based MLA, clustering based MLA, Bayesian networks, reinforcement learning based MLA, representation learning based MLA, similarity and metric learning based MLA, sparse dictionary learning based MLA, genetic algorithms based MLA, and the like. For training the MLA 280, the server 250 may have employed a supervised-learning approach without departing from the scope of the present technology.

In some non-limiting embodiments of the present technology, the MLA 280 can comprise a Deep Structured Semantic Model (DSSM). Broadly speaking, DSSM is a deep NN that can be trained to represent input data, such as that of the digital items and users of the digital recommendation platform 260 in a continuous semantic space and model semantic similarity between two features representative of given pieces of the input data. For example, such features can include user features of the user 220 and item features of the plurality of items 235 of the digital recommendation platform 260.

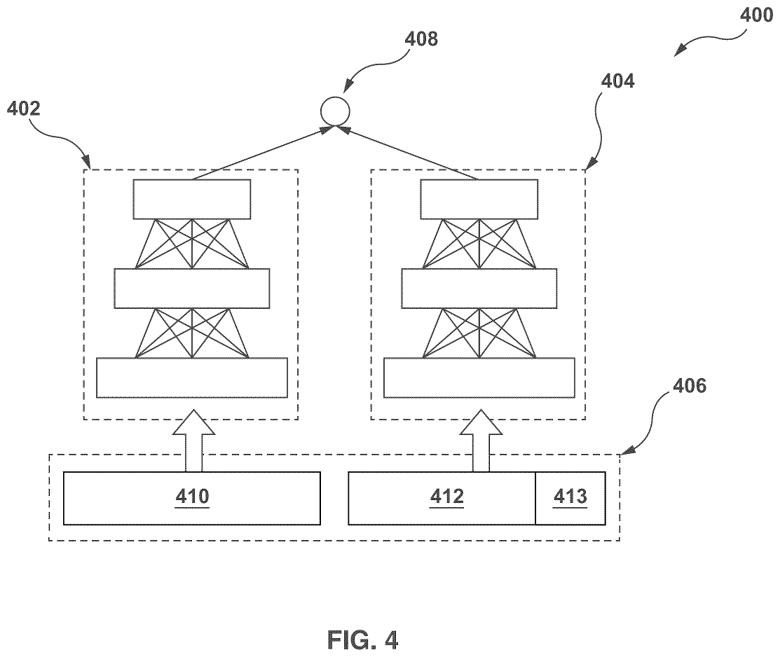

An example machine-learning model, based on which the MLA 280 can be implemented, in at least some non-limiting embodiments of the present technology, will be described immediately below with reference to FIG. 4.

### Machine-learning Model Architecture

With reference to FIG. 4, there is depicted a schematic diagram of a machine-learning model (MLM) architecture 400 that can be used with at least some non-limiting embodiments of the present technology. The MLM architecture 400 aims at illustrating a generic DSSM which may be modified so as to meet the requirements of a specific prediction model, such as the MLA 280. Such modifications may include, for example, but without being limited, adding or removing one or more layers, increasing a number of nodes in a given layer, and the like.

According to certain non-limiting embodiments of the present technology, the MLM architecture 400 can comprise two NN: a user NN 402 and item NN 404, each of which is configured to generate, based on a respective piece of the input data, a respective output vector of a multidimensional semantic space, representing a semantic meaning of the respective piece of the input data. The respective output vector can include between 100 and 500 of floating-point values, as an example. According to certain non-limiting embodiments of the present technology, the input data can be provided from digital objects, such as a given training digital object 406, generation of which will be described below.

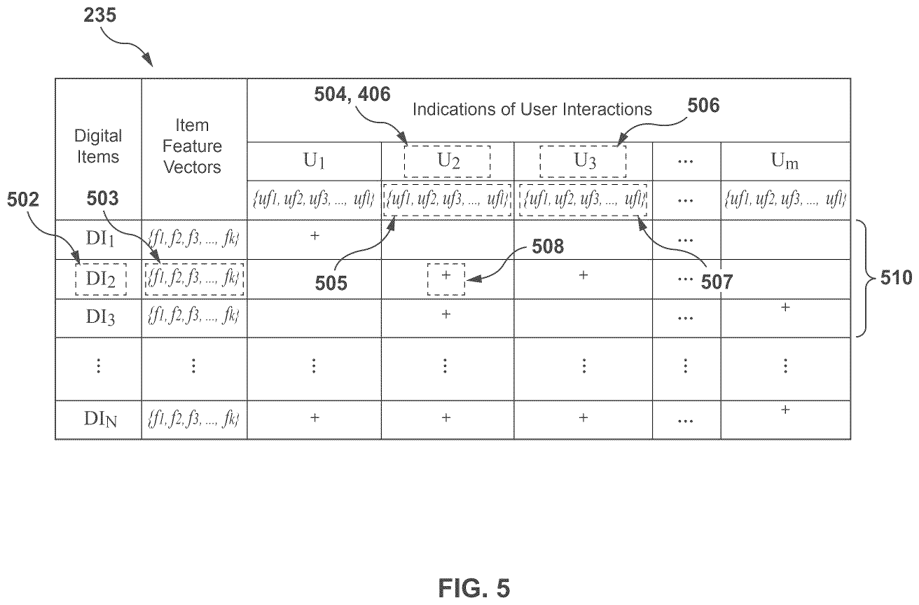

More specifically, according to certain non-limiting embodiments of the present technology, the respective piece of the input data for the user NN 402 can be a plurality of user features 410 including user features mentioned above of one of the users of the digital recommendation platform 260, such as a given prior user 504 depicted in FIG. 5. Similarly, the respective piece of the input data for the item NN 404 can include: (i) a target plurality of item features 412 of a target digital item (such as a given least interacted digital item 502 schematically depicted in FIG. 5); and (ii) a respective label 413 including an indication of the user interaction, as described above, of the given prior user 504 with the given least interacted digital item 502.

It is not limited how the server 250 can be configured to generate the plurality of user features 410 and the target plurality of item features 412 for inputting to the user and item NNs 402, 404 of the MLM architecture 400 and can comprise applying an embedding algorithm (not depicted) to the item and user features. Broadly speaking, the embedding algorithm is configured to generate a fixed-dimensional numerical representations of the input data, that is, user or item features. A respective implementation of the embedding algorithm will depend on a format of the input data. For example, if the input data, that is, the user and item features, are represented by text, the embedding algorithm can comprise a text embedding algorithm. According to certain non-limiting embodiments of the present technology, the text embedding algorithm can comprise, without limitation, one of: a one-hot encoding algorithm, a Term frequency-inverse document frequency (TF-IDF) embedding algorithm, a Word2Vec embedding algorithm, and a FastText embedding algorithm. For example, a vector of a given one of the plurality of user features 410 and the target plurality of item features 412 generated by the embedding algorithm, can include from 50 to 1024 floating-point values.

Thus, each one of the user and item NNs 402, 404 is configured to transform the respective input features to a lower-dimensional output vector in the multidimensional semantic space. To do so each one of the user and item NNs 402, 404, can include a respective plurality of fully connected layers. In some non-limiting embodiments of the present technology, at lest one NN of the user and item NNs 402, 404 can be configured to reduce the dimensionality of the respective one of the plurality of user features 410 and the target plurality of item features 412. To that end, each consecutive layer of at least some layers of the given NN of the user and item NNs 402, 404 can include fewer nodes (also referred to herein as “neurons”) than a preceding one. For example, the number of nodes in each consecutive layer of the at least some layers can decrease by a factor of 2, such as 1024, 512, 256, and so on. Also, according to certain non-limiting embodiments of the present technology, a number of layers in each of the user and item NNs 402, 404 is not limited, and can include, for example, 4, 20, or 100 layers, as an example. In some non-limiting embodiments of the present technology, the user NN 402 can be structured, that is, have a similar number of layers and nodes therein, similarly to the item NN 404. However, in other non-limiting embodiments of the present technology, different structures of the user NN 402 and item NN 404 are also envisioned.

According to certain non-limiting embodiments of the present technology, an output 408 of the MLM architecture 400 is a similarity score, representative of a predicted indication of the user interaction of the given prior user 504, represented by the plurality of user features 410, with the given least interacted digital item 502 of the plurality of items 235. In other words, the similarity score is representative of how closely the output vectors of the user and item NNs 402, 404, generated in response to feeding thereto the plurality of user features 410 and the target plurality of item features 412, are located in the multidimensional semantic space. According to certain non-limiting embodiments of the present technology, the similarity score can be determined using a cosine similarity function, as an example.

For adjusting the weights of the nodes of the MLM architecture 400 during the training process, the server 250 can be configured to: (i) apply a backpropagation algorithm to the MLM architecture 400, (ii) determine a difference between the respective label 413 of the given training digital object 406, that is, the indication of the user feedback to the target digital item, and the output 408, and (iii) minimize the determined difference. Such difference can be expressed by a loss function, such as a Cross-Entropy Loss Function. In other words, the loss functions is configured to penalize the output 408 in response to the output 408 being different from the respective label 413 of the given training digital object 406.

It should be expressly understood that other implementations of the loss function are also envisioned by the non-limiting embodiments of the present technology and may include, by way of example, and not as a limitation, a Mean Squared Error Loss function, a Huber Loss function, a Hinge Loss function, and others. Also, in those embodiments where the similarity score is determined using the cosine similarity function, the loss functions is referred to as a “cosine similarity loss function.”

It will be understood that the architecture of the MLM architecture 400 described with reference to FIG. 4 has been simplified for ease of understanding; and an actual implementation of the MLM architecture 400 may include additional layers. In one non-limiting example, the MLM architecture 400 can be implemented as described in an article entitled “Deep Structured Semantic Model for Recommendations in E-commerce,” authored by Larionova et al. and published at researchgate.net on Jun. 11, 2021, the content of which is incorporated herein by reference in its entirety. In another non-limiting example, the MLM architecture 400 can be implemented as described in an article entitled “DSSMFM: Combining User and Item Feature Interactions for Recommendation Systems,” authored by Zeng, and published on Jan. 1, 2020, in the proceedings of 2019 International Conference on Computer Science Communication and Network Security (CSCNS2019), the content of which is incorporated herein by reference in its entirety.

In some non-limiting embodiments of the present technology, the MLA 280 can comprise a single MLA that is implemented based on the MLM architecture 400 described. In other non-limiting embodiments of the present technology, the MLA 280 can comprise two MLAs: (1) a first MLA that is implemented based on the MLM architecture 400; and (2) a second MLA (not depicted) that is coupled to the first MLA such that an output thereof, that is, the output 408 of the MLM architecture 400, is input to the second MLA as part of other input features for identifying the set of recommended digital items 225. In other words, in these embodiments, the server 235 can be configured to use the output 408 as an input feature to the second MLA. How the second MLA can be implemented is not limited and, in some non-limiting embodiments of the present technology, the second MLA can be implemented akin to the first MLA and comprise an NN. In other non-limiting embodiments of the present technology, the second MLA can comprise a decision tree-based MLM (not depicted). In specific non-limiting embodiments of the present technology, the decision tree-based MLM can comprise a CatBoost ensemble of decision trees, as described, for example, in an article “CatBoost: gradient boosting with categorical features support” by Dorogush et al., and published by YANDEX INC., the content of which is incorporated herein by reference in its entirety.

Generally speaking, the processor of the server 250 can be said to be executing two separate processes in respect of the MLA 280. A first process of the two processes is a training process, where the server 250 is configured to train the MLA 280, based on the plurality of training digital objects (also referred to herein as a “training set of data”), thereby mapping, in the multidimensional space, output vectors of the item NN 404 of the MLA 280 representative of item features of the plurality of digital items 235 relative to output vectors of the user NN 402 of the MLA 280 representative of respective user features of each user of the digital recommendation platform 260, such as the user 220.

A second process is an in-use process, where the processor of the server 250 executes the so-trained MLA 280 for determining the predicted indications of the user 220 with each digital item of the plurality of digital items 235 given current locations of respective output vectors representative of the item feature of the plurality of digital items 235 in the multidimensional semantic space after executing the training process. However, in some non-limiting embodiments of the present technology, the MLA can be trained at a third-party server; and the server 250 can be configured to execute the MLA 280.

The training process of the MLA 280 will now be described.

### Training Process

According to certain non-limiting embodiments of the present technology, to train the MLA 280, the server 250 can be configured to generate a training set of data. With reference to FIG. 5, there is depicted a schematic diagram of a step for generating the given training digital object 406, in accordance with certain non-limiting embodiments of the present technology.

According to certain non-limiting embodiments of the present technology, to generate the training set of data, the server 250 can be configured to identify least interacted digital items of the digital recommendation platform 260, such as a set of least interacted digital items 510.

According to certain non-limiting embodiments of the present technology, the server 250 can be configured to identify the set of least interacted digital items 510 as including digital items, with which only a predetermined proportion of the users of the digital recommendation platform 260 has interacted, such as 5%, 10%, or 15%, as an example. In some non-limiting embodiments of the present technology, the server 250 can be configured to identify the set of least interacted digital items 510 as including digital items that have received no more than a predetermined number of user interactions, such as a respective user interaction 508 of the given prior user 504. For example, in these embodiments, the server 250 can be configured to identify the set of least interacted digital items 510 as including digital items that have received, over a predetermined period, such as one day, one week, or one month, for example, no more than 5, 10, or 100 user interactions, which were described above.

In yet other non-limiting embodiments of the present technology, as schematically depicted in FIG. 5, the server 250 can be configured to identify the set of least interacted digital items 510 by: (i) ranking the plurality of digital items 235 in accordance with a respective number of indications of user interactions therewith, thereby generating a ranked list of digital items of the digital recommendation platform 260 (not depicted); and (ii) selecting a predetermined number of bottom N digital items, such as thousands, tens of thousands, or even millions digital items, from the list of ranked digital items.

Further, for each least interacted digital item of the set of least interacted digital items 510, the server 250 can be configured to generate a respective training digital object, such as the given training digital object 406 for the given least interacted digital item 502. To do so, according to certain non-limiting embodiments of the present technology, the server 250 can be configured to generate, for the given least interacted digital item 502, the target plurality of item features 412. As will become apparent from the description provided hereinbelow, the target plurality of item features 412 can be also referred to herein as an “an augmented plurality of item features.”

According to certain non-limiting embodiments of the present technology, the server 250 can be configured to generate the target plurality of item features 412 for the given least interacted digital item 502 based on: (i) a respective plurality of item features 503 associated with the given least interacted digital item 502, generated using the embedding algorithm described above; and (ii) a combination of respective pluralities of user features of users who have interacted with the given least interacted digital item 502 that, in the present example, are a first plurality of user features 505 and a second plurality of user features 507 associated with the given prior user 504 and an other prior user 506, respectively. For example, in some non-limiting embodiments of the present technology, to generate the combination of the first and second pluralities of user features 505, 507, the server 250 can be configured to concatenate the first and second pluralities of user features 505, 507, thereby generating a combined plurality of user features (not depicted).

Further, according to certain non-limiting embodiments of the present technology, to generate the target plurality of item features 412 for the given least interacted digital item 502, the server 250 can be configured to combine the respective plurality of item features 503 of the given least interacted digital item 502 with the combined plurality of user features of the first and second pluralities of user features 505, 507, generated as described above.

Thus, according to certain non-limiting embodiments of the present technology, the server 250 can be configured to generate the given training digital object 406 that includes: (i) the first plurality of user features 505 of the given prior user 504; (ii) the target plurality of item features 412 of the given least interacted digital item 502, with which the given prior user 504 has interacted; and (iii) the respective label 413 including an indication of the respective user interaction 508 of the given prior user 504 with the given least interacted digital item 502.

In some non-limiting embodiments of the present technology, the server 250 can be configured to include in the given training digital item 406 a combination of respective item features of other digital items of the plurality of digital items 235 with which the given prior user 504 has interacted.

In a similar fashion, the server 250 can be configured to generate respective training digital objects of the plurality of training digital objects for other prior users of the digital recommendation platform 260 that have interacted with at least one least interacted digital item of the set of least interacted digital items 510. According to certain non-limiting embodiments of the present technology, the plurality of training digital objects can include thousands, tens or even hundreds of thousands of training digital objects for training the MLA 280.

According to certain non-limiting embodiments of the present technology, for those prior users of the digital recommendation platform 260 who have not interacted with at least one of the set of least interacted digital items 510, the server 260 can be configured to generate an other given training digital object of the plurality of training digital objects that includes: (i) the respective plurality of user features of a yet other given prior user (not depicted) of these users; (ii) the respective plurality of item features of at least one digital item with which the yet other given prior user has interacted; and (ii) the respective label 413 including an indication of the user interaction mentioned above (like the respective user interaction 508 of the given prior user 504) of the yet other prior user with the at least one prior item.

Further, according to certain non-limiting embodiments of the present technology, at a respective training iteration, the server 250 can be configured to feed the given training digital object 406 of the plurality of training digital objects to the MLA 280, thereby causing the MLA 280 to generate a respective predicted indication of the user interaction of the given prior user 504 with the given least interacted digital item 502. Further, the server 250 can be configured to apply the loss function described above that is configured to penalize the respective predicted indication of the user interaction with the given least interacted digital item 502 in response to the respective predicted indication being different from the actual indication of the user interaction in the respective label 413 of the given training digital object 406.

By doing so, the server 250 can be configured to train the MLA 280 to define the multidimensional semantic space where the respective output vector, generated by the item NN 404 of the MLA 280, representative of the target plurality of item features 412 of the given least interacted digital item 406 would be located in the multidimensional semantic space closer to the respective output vectors, generated by the user NN 402 of the MLA 280, representative of the user features of those users whose user feature are similar to those of the given prior user 504. In other words, the more similar are the user features of the user 220 to the those of the given prior user 504, the closer the respective output vector representative of target plurality of item features 412 would be located to that representative the respective plurality of user features of the user 220 in the so generated, via the training process of the MLA 280, multidimensional semantic space. This may enable the server 250 to more likely identify the given least interacted digital item 502 for inclusion thereof in the set of recommended digital items 225 for the user 220.

Also, in some non-limiting embodiments of the present technology, where the MLA 280 comprises the first and second MLAs, the first MLA being implemented based on the MLM architecture 400 described above, the server 250 can be configured to train both MLAs jointly. To do so, the server 250 can be configured to: (i) feed the given training digital object 406 to the first MLA, thereby causing the first MLA to generate the output 408 including a first predicted indication of the user interaction with the given least interacted digital item 502; (ii) input the first predicted indication of the user interaction to the second MLA, along with other input features of the second MLA, thereby causing the second MLA to generate a second predicted indication of the user interaction; and (iii) applying the loss function to the second predicted indication of the user interaction generated by the second MLA. In those embodiments where the second MLA is the CatBoost ensemble of decision trees, more details on training the second MLA including the other input features can be obtained from the article by Dorogush et al. referenced above.

After training the MLA 280, the server 250 can be configured to use the MLA 280 for identifying the set of recommended digital items 225, which will be described immediately below.

### In-Use Process

According to certain non-limiting embodiments of the present technology, the server 250 can be configured to use the MLA 280, trained as described above, for identifying, in response to the recommendation request 215, in the plurality of digital items 235 of the digital recommendation platform 260, next digital items to be provided to the user 220 that are among the least popular, that is, the least interacted digital items by the users of the digital recommendation platform 260. Further, the server 250 can be configured to include these digital items in the set of recommended digital items 225 and transmit data representative thereof to the electronic device 210 for presentation to the suer 220.

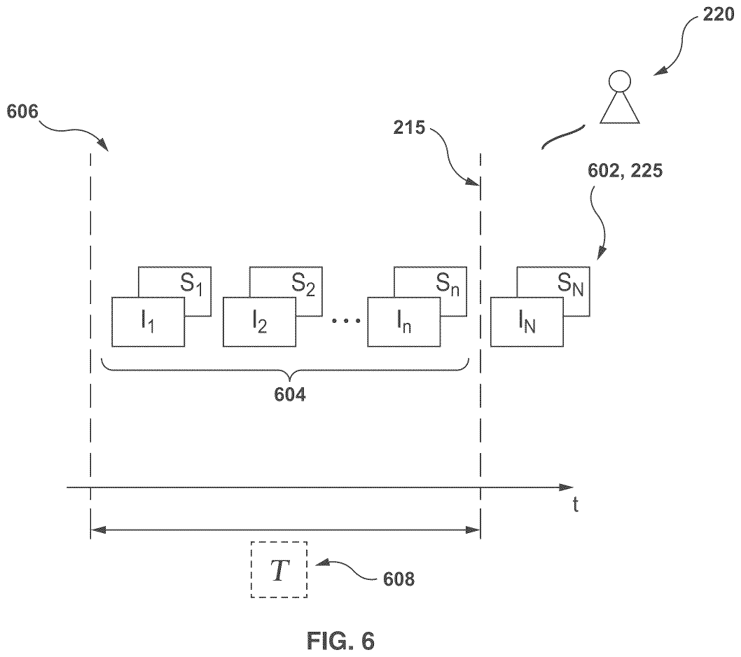

With reference to FIG. 6, there is depicted a schematic diagram of a process for generating an in-use digital object 606 for generating the set of recommended digital items 225, in accordance with certain non-limiting embodiments of the present technology.

According to certain non-limiting embodiments of the present technology, the server 250 can be configured to: (i) by the moment of receiving the recommendation request 215, identify, over a scanning period 608, a set of in-use past digital items 604 with which the user 220 has interacted during the scanning period 608; and (ii) similar to the combination of the respective pluralities of item features mentioned above with respect to the given training digital object 406, generate an in-use combination of item features (not depicted) for the set of in-use past digital items 604. Further, the server 250 can be configured to generate the in-use digital object 606 including: (1) the plurality of user features of the user 220 and (2) the in-use combination of item features of the set of in-use past digital items 604. Further, the server 250 can be configured to feed the in-use digital object 606 to the MLA 280, thereby causing the MLA 280 to identify an in-use target digital item 602. As mentioned above, the so identified in-use target digital item 602 could be the given least interacted digital item 502 of the set of least interacted digital items 510 if the user features of the user 220 are similar to those of the given prior user 504 having been interacted with the given least interacted digital item 502. In other words, if the user features of the user 220 are similar to those of the given prior user 504, in the multidimensional semantic space defined by the server 250 via executing the training process of the MLA 280, the respective output vector, generate by the item NN 404, representative of the given least interacted digital item 502 would be close to those, generated by the user NN 402, representative of the respective plurality of user features of the user 220.

In those non-limiting embodiments of the present technology where the MLA 280 comprises two MLAs, the server 250 can be configured to use the first MLA to identify the in-use target digital item 602 as described above. Further, the server 250 can be configured to: (i) generate, based on the in-use target digital item, a respective in-use target item feature vector (not depicted) using the embedding algorithm mentioned above; and (ii) feed the respective in-use target item feature vector along with the other input features to the second MLA, thereby causing the second MLA to identify, in the plurality of digital items 235 of the digital recommendation platform 260, the set of recommended digital items 225. Alternatively, in some non-limiting embodiments of the present technology, instead of the respective in-use target item feature vector generated by the embedding algorithm, the server 250 can be configured to feed to the second MLA the respective output vector of the item NN 404 generated thereby in response to receiving the in-use digital object 606.

Further, the server 250 can be configured to transmit data representative of the set of recommended digital items 225 to the electronic device 210 of the user 220, enabling the user 220 to appreciate the set of recommended digital items 225, for example, via GUI 300 of the digital recommendation platform 260, as described above with reference to FIG. 3.

Thus, by applying the MLA 280 for identifying the in-use target digital item 602, the server 250 can be configured to generate the set of recommended digital items 225 that would enable the user 220 to appreciate more diverse, less popular, content of the digital recommendation platform 260, which may enhance user experience of the user 220 with the digital recommendation platform 260.

### Method

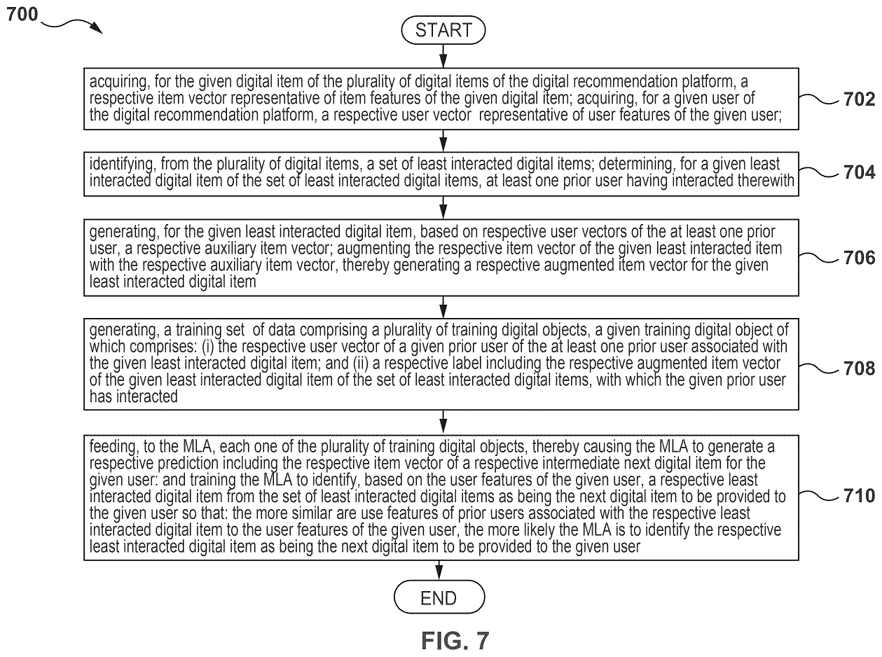

Given the architecture and the examples provided hereinabove, it is possible to execute a method for generating digital item recommendations for users of the digital recommendation platform 260, such as the user 220 mentioned above. With reference now to FIG. 7, there is depicted a flowchart of a method 700, according to certain non-limiting embodiments of the present technology. The method 700 may be executed by server 250.

As mentioned hereinabove, the server 250 can be configured to identify the digital items for the set of recommended digital items by using the MLA 280. In some non-limiting embodiments of the present technology, the MLA 280 can be implemented based on the MLM architecture 400 described in detail above with reference to FIG. 4. In some non-limiting embodiments of the present technology, as mentioned also above with reference to FIG. 4, the MLA 280 can comprise a single MLA that is implemented based on the MLM architecture 400. In ither non-limiting embodiments of the present technology, the MLA 280 can comprise the first MLA, implemented based on the MLM architecture 400, and the second MLA, implemented, for example, as a decision tree-based MLA, such as en ensemble of CatBoost decision trees referenced above.

### Step 702: Acquiring, for the Given Digital Item of the Plurality of Digital Items, a Respective Plurality of Item Features of the Given Digital Item Including a Respective Source Associated Therewith; Acquiring, for the Given User of the Digital Recommendation Platform, a Respective Plurality of User Features of the Given User

The method 700 commences with step 702 with the server 250 being configured to acquire data for generating the training set of data for training the MLA 280. More specifically, the server 250 can be configured to acquire: (i) respective pluralities of user features of users of the digital recommendation platform 260, such as the plurality of user features 410 of the user 220; and (ii) the item feature of digital items of the plurality of items 235 stored by the digital recommendation platform 260, such as the target plurality of item features 412 of the given least interacted digital item 502.

The method 700 hence advances to step 704.

### Step 704: Identifying, from the Plurality of Digital Items, a Set of Least Interacted Digital Items; Determining, for a Given Least Interacted Digital Item of the Set of Least Interacted Digital Items, at Least One Prior User Having Interacted Therewith

At step 704, according to certain non-limiting embodiments of the present technology, the server 250 can be configured to identify the set of least interacted digital items 510 as described in detail above with reference to FIG. 5.

More specifically, in some non-limiting embodiments of the present technology, the server 250 can be configured to identify the set of least interacted digital items 510 as including digital items, with which only a predetermined proportion of the users of the digital recommendation platform 260 has interacted, such as 5%, 10%, or 15%, as an example. In some non-limiting embodiments of the present technology, the server 250 can be configured to identify the set of least interacted digital items 510 as including digital items that have received no more than a predetermined number of user interactions, such as a respective user interaction 508 of the given prior user 504. For example, in these embodiments, the server 250 can be configured to identify the set of least interacted digital items 510 as including digital items that have received, over a predetermined period, such as one day, one week, or month, for example, no more than 5, 10, or 100 user interactions, which were described above.

In yet other non-limiting embodiments of the present technology, as schematically depicted in FIG. 5, the server 250 can be configured to identify the set of least interacted digital items 510 by: (i) ranking the plurality of digital items 235 in accordance with a respective number of indications of user interactions therewith, thereby generating a ranked list of digital items of the digital recommendation platform 260 (not depicted); and (ii) selecting a predetermined number of bottom N digital items, such as thousands, tens of thousands, or even millions of digital items, from the list of ranked digital items.

The method 700 hence advances to step 706.

### Step 706: Generating, for the Given Least Interacted Digital Item, Based on Respective Pluralities of User Features of the at Least One Prior User, a Respective Auxiliary Plurality of Item Features; Augmenting the Respective Plurality of item Features of the Given Least Interacted Item with the Respective Auxiliary Plurality of Item Features, Thereby Generating a Respective Augmented Plurality of Item Features for the Given Least Interacted Digital Item

At step 706, according to certain non-limiting embodiments of the present technology, the server250 can be configured to generate, for each one of the set of least interacted digital items 510, a respective augmented item feature vector, such as the target plurality of item features 412 for the given least interacted digital item 502. To do so, as described further above with reference to FIG. 5, the server 250 can be configured to generate the combination of: (i) the respective plurality of item features 503 associated with the given least interacted digital item 502; and (ii) the respective pluralities of user features of the prior users who have interacted with the given least interacted digital item 502, that is, the first plurality of user features 505, associated with the given prior user 504, and the second plurality of user features 507, associated with the other prior user 506.

The method 700 hence advances to step 708.

### Step 708: Generating a Training Set of Data Comprising a Plurality of Training Digital Objects, a Given Training Digital Object of Which Comprises: (I) the Respective Plurality of User Features of a Given Prior User of the at Least One Prior User Associated with the Given Least Interacted Digital Item; and (II) a Respective Label Including the Respective Augmented Plurality of Item Features of the Given Least Interacted Digital Item of the Set of Least Interacted Digital Items, with Which the Given Prior User has Interacted

At step 708, according to certain non-limiting embodiments of the present technology, using the respective augmented item feature vectors of each least interacted digital item of the set of least interacted digital items 510, generated at step 706, the server 250 can be configured to generate the training set of data for training the MLA 280 to identify the set of recommended digital items 225.

Mores specifically, according to certain non-limiting embodiments of the present technology, the server 250 can be configured to generate the given training digital object 406 of the plurality of training digital objects that includes: (i) the first plurality of user features 505 of the given prior user 504; (ii) the target plurality of item features 412 of the given least interacted digital item 502, with which the given prior user 504 has interacted; and (iii) the respective label 413 including the indication of the respective user interaction 508 of the given prior user 504 with the given least interacted digital item 502.

In some non-limiting embodiments of the present technology, the server 250 can be configured to include in the given training digital item 406 the combination of item features of other digital items of the plurality of digital items 235 with which the given prior user 504 has interacted.

The method 700 hence advances to step 710.

### Step 710: Feeding, to the mla, Each One of the Plurality of Training Digital Objects, Thereby Causing the MLA to Generate A Respective Prediction Including the Respective Plurality of Item Features of a Respective Intermediate Next Digital Item for the Given User; and Training the MLA to Identify, Based on the User Features of the Given User, a Respective Least Interacted Digital Item from the Set of Least Interacted Digital Items as Being the Next Digital Item to be Provided to the Given User so That: the More Similar are User Features of Prior Users Associated with the Respective Least Interacted Digital item to the user features of the given user, the more Likely the MLA is to Identify the Respective Least Interacted Digital Item as Being the Next Digital Item to be Provided to the Given User

At step 710, according to certain non-limiting embodiments of the present technology, the server 250 can be configured to feed the plurality of training digital objects generated at step 708 to the MLA 280 to train it.

More specifically, according to certain non-limiting embodiments of the present technology, at the respective training iteration, the server 250 can be configured to feed the given training digital object 406 of the plurality of training digital objects to the MLA 280, thereby causing the MLA 280 to generate a respective predicted indication of the user interaction of the given prior user 504 with the given least interacted digital item 502. Further, the server 250 can be configured to apply the loss function described above that is configured to penalize the respective predicted indication of the user interaction with the given least interacted digital item 502 in response to the respective predicted indication being different from the actual indication of the user interaction in the respective label 413 of the given training digital object 406.

By doing so, the server 250 can be configured to train the MLA 280 to define the multidimensional semantic space where the respective output vector, generated by the the MLA 280, representative of the target plurality of item features 412 of the given least interacted digital item 406 would be located closer to the respective output vectors, generated by the MLA 280, representative of the respective pluralities of user features of those users whose user features are similar to those of the given prior user 504. In other words, the more similar are the user features of the user 220 to the those of the given prior user 504, the closer the respective output vector of the target plurality of item features 412 of the given least interacted digital item 502 would be located to the respective output vector of the respective plurality of user features of the user 220 in the so generated, via the training process of the MLA 280, multidimensional semantic space. This may enable the server 250 to more likely identify the given least interacted digital item 502 for inclusion thereof in the set of recommended digital items 225 for the user 220.

Also, in some non-limiting embodiments of the present technology, where the MLA 280 comprises the first and second MLAs, the first MLA being implemented based on the MLM architecture 400 described above, the server 250 can be configured to train both MLAs jointly. To do so, the server 250 can be configured to: (i) feed the given training digital object 406 to the first MLA, thereby causing the first MLA to generate the output 408 including a first predicted indication of the user interaction with the given least interacted digital item 502; (ii) input the first predicted indication of the user interaction to the second MLA, along with other input features of the second MLA, thereby causing the second MLA to generate a second predicted indication of the user interaction; and (iii) applying the loss function to the second predicted indication of the user interaction generated by the second MLA.

The method 700 thus terminates.

Thus, certain embodiments of the method 700 may allow diversifying the set of recommended digital items 225 for the user 220 by including therein less interacted digital items that may be of interest to the user 220. This may prevent the user 220 from being introduced only to the most popular digital items of the digital recommendation platform 260 and can thus improve the user experience of the user 220 from interacting with the digital recommendation platform 260.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

1. A computer-implemented method for generating item recommendations for users of a digital recommendation platform, the digital recommendation platform storing a plurality of digital items, the method comprising:
training a machine-learning algorithm (MLA) to identify a next digital item from the plurality of digital items to be provided to a given user, the training including:
acquiring, for the given digital item of the plurality of digital items of the digital recommendation platform, a respective plurality of item features of the given digital item;
acquiring, for a given user of the digital recommendation platform, a respective plurality of user features of the given user;
identifying, from the plurality of digital items, a set of least interacted digital items;
determining, for a given least interacted digital item of the set of least interacted digital items, at least one prior user having interacted therewith;
generating, for the given least interacted digital item, based on respective pluralities of user features of the at least one prior user, a respective auxiliary plurality of item features;
augmenting the respective plurality of item features of the given least interacted item with the respective auxiliary plurality of item features, thereby generating a respective augmented plurality of item features for the given least interacted digital item;
generating a training set of data comprising a plurality of training digital objects, a given training digital object of which comprises: (i) the respective plurality of user features of a given prior user of the at least one prior user associated with the given least interacted digital item; and (ii) a respective label including the respective augmented plurality of item features of the given least interacted digital item of the set of least interacted digital items, with which the given prior user has interacted;
feeding, to the MLA, each one of the plurality of training digital objects, thereby causing the MLA to generate a respective prediction including the respective plurality of item features of a respective intermediate next digital item for the given user; and
training the MLA to identify, based on the user features of the given user, a respective least interacted digital item from the set of least interacted digital items as being the next digital item to be provided to the given user so that:
the more similar are user features of prior users associated with the respective least interacted digital item to the user features of the given user, the more likely the MLA is to identify the respective least interacted digital item as being the next digital item to be provided to the given user.

2. The method of claim 1, wherein the given training digital object further comprises a combination of respective pluralities of item features of other digital items with which the given prior user has interacted.

3. The method of claim 1, wherein identifying the given least interacted digital item of the set of least interacted digital items comprises identifying a digital item with which no more than a predetermined proportion of the users of the digital recommendation platform has interacted.

4. The method of claim 1, wherein identifying the given least interacted digital item of the set of least interacted digital items comprises identifying a digital item having no more than a predetermined number of indications of user interactions.

5. The method of claim 1, wherein the identifying the set of least interacted digital items comprises:
ranking the plurality of digital items of the digital recommendation platform in accordance with indications of user interactions therewith, thereby generating a ranked list of digital items; and
selecting bottom N digital items from the ranked list of digital items.

6. The method of claim 1, wherein the generating the respective auxiliary plurality of item features comprises determining a combination of the respective pluralities of user features of the at least one prior user having interacted with the given least interacted digital items.

7. The method of claim 1, wherein the augmenting the respective plurality of item features of the given least interacted item with the respective auxiliary plurality of item features comprises determining a combination of the respective plurality of item features and the respective auxiliary plurality of item features.

8. The method of claim 1, wherein the training comprises using a cosine similarity loss function.

9. The method of claim 1, further comprising using the MLA for generating the item recommendations for the given user, by:
generating an in-use digital object that includes: (i) the respective plurality of user features of the given user; and (ii) a combination of respective pluralities of item features of past digital items with which the given user has interacted;
feeding the in-use digital object to the MLA, thereby causing the MLA to identify, in the plurality of digital items, a given in-use digital item; and
causing presentation of the given in-use digital item as being the next digital item for the given user.

10. The method of claim 9, wherein prior to the causing, the method further comprises:
generating a respective item feature vector representative of the given digital item;
feeding the respective item vector of the given digital item as an input feature to a second MLA, thereby causing the second MLA to identify, in the plurality of digital items, a given other in-use digital item;
the second MLA having been trained to generate the item recommendation based on outputs of the MLA; and
causing presentation of the given other in-use digital item as being the next digital item for the given user.

11. The method claim 10, wherein the second MLA comprises a Gradient Boosting Decision Tree-based MLA.

12. The method of claim 1, wherein the MLA comprises a Deep Semantic Similarity Model (DSSM).

13. A server for generating item recommendations for users of a digital recommendation platform, the digital recommendation platform storing a plurality of digital items, the server comprising at least one processor and at least one non-transitory computer-readable medium storing executable instructions, which, when executed by the at least one processor, cause the server to:
train a machine-learning algorithm (MLA) to identify a next digital item from the plurality of digital items to be provided to a given user, by:
acquiring, for the given digital item of the plurality of digital items of the digital recommendation platform, a respective plurality of item features of the given digital item;
acquiring, for a given user of the digital recommendation platform, a respective plurality of user features of the given user;
identifying, from the plurality of digital items, a set of least interacted digital items;
determining, for a given least interacted digital item of the set of least interacted digital items, at least one prior user having interacted therewith;
generating, for the given least interacted digital item, based on respective pluralities of user features of the at least one prior user, a respective auxiliary plurality of item features;
augmenting the respective plurality of item features of the given least interacted item with the respective auxiliary plurality of item features, thereby generating a respective augmented plurality of item features for the given least interacted digital item;
generating a training set of data comprising a plurality of training digital objects, a given training digital object of which comprises: (i) the respective plurality of user features of a given prior user of the at least one prior user associated with the given least interacted digital item; and (ii) a respective label including the respective augmented plurality of item features of the given least interacted digital item of the set of least interacted digital items, with which the given prior user has interacted;
feeding, to the MLA, each one of the plurality of training digital objects, thereby causing the MLA to generate a respective prediction including the respective plurality of item features of a respective intermediate next digital item for the given user; and
training the MLA to identify, based on the user features of the given user, a respective least interacted digital item from the set of least interacted digital items as being the next digital item to be provided to the given user so that:
the more similar are user features of prior users associated with the respective least interacted digital item to the user features of the given user, the more likely the MLA is to identify the respective least interacted digital item as being the next digital item to be provided to the given user.

14. The server of claim 13, wherein the given training digital object further comprises a combination of respective plurality of item features of other digital items with which the given prior user has interacted.

15. The server of claim 13, wherein to identify the given least interacted digital item of the set of least interacted digital items, the executable instructions further cause the server to identify a digital item with which no more than a predetermined proportion of the users of the digital recommendation platform has interacted.

16. The server of claim 13, wherein to identify the given least interacted digital item of the set of least interacted digital items, the executable instructions further cause the server to identify a digital item having no more than a predetermined number of indications of user interactions.

17. The server of claim 13, wherein to identify the set of least interacted digital items, the executable instructions cause the server to:
rank the plurality of digital items of the digital recommendation platform in accordance with indications of user interactions therewith, thereby generating a ranked list of digital items; and
select bottom N digital items from the ranked list of digital items.

18. The server of claim 13, wherein to generate the respective auxiliary plurality of item features, the executable instructions cause the server to determine a combination of the respective pluralities of user features of the at least one prior user having interacted with the given least interacted digital items.

19. The server of claim 13, wherein to augment the respective plurality of item features of the given least interacted item with the respective auxiliary plurality of item features, the executable instructions cause the server to determine a combination of the respective plurality of item features and the respective auxiliary plurality of item features.

20. The server of claim 13, wherein the executable instructions further cause the server to use the MLA for generating the item recommendations for the given user, by:
generating an in-use digital object that includes: (i) the respective plurality of user features of the given user; and (ii) a combination of respective pluralities of item features of past digital items with which the given user has interacted;
feeding the in-use digital object to the MLA, thereby causing the MLA to identify, in the plurality of digital items, a given in-use digital item; and
causing presentation of the given in-use digital item as being the next digital item for the given user.
